(19) United States
(12) Patent Application Publication
(10) Pub. No.: US 2026/0229732 A1
(43) Pub. Date: Aug. 6, 2026

(54) SLOTTED TERMINAL PLATE

(71) Applicant: GM Global Technology Operations LLC, Detroit, MI (US)

(72) Inventors: Edrick Joe, Oak Park, MI (US); Shuonan Xu, Troy, MI (US); Junjie Ma, Novi, MI (US); Neeraj S. Shidore, Novi, MI (US); Jian Gao, Auburn Hills, MI (US)

(21) Appl. No.: 19/045,066

(22) Filed: Feb. 4, 2025

(51) Int. Cl. H01M 50/555; H01M 50/249; H01M 50/562

(52) U.S. Cl. CPC H01M 50/555; H01M 50/249; H01M 50/562; H01M 2220/20

(57) ABSTRACT

A battery for a vehicle includes an energy storage portion. A first terminal plate physically contacts, and is electrically connected to, the energy storage portion via a first interior facing surface. A second terminal plate physically contacts, and is electrically connected to, the energy storage portion via a second interior facing surface. The first terminal plate includes at least one groove extending into the first terminal plate from a first exterior facing surface. The first exterior facing surface is opposite the first interior facing surface. A skin effect of the first terminal plate at the exterior surface extends from a circumference of the first terminal plate and from each edge of the at least one groove when an alternating current passes through the first terminal plate.

The subject disclosure relates to battery cells, and more particularly to a slotted terminal plate design for a battery cell.

Electric vehicles and hybrid electric vehicles use batteries to store electric power generated during operation and/or received from an exterior source through charging. The stored electric power is used to operate on board electronic systems. In a hybrid electric vehicle the power may also be used to supplement power from internal combustion engines. In a pure electric vehicle the electric power is provided to electric drive motors and the electric drive motors drive rotation of the wheels.

Some example vehicle batteries are constructed of multiple individual battery cells connected together, with each cell being connected to a positive voltage connection via a terminal and a negative voltage connection via another terminal. With existing terminal designs, a skin effect at the terminal can cause current passing through the terminal to be concentrated at exterior edges of the terminal.

Accordingly, it is desirable to provide battery terminal structure that allows full power to be provided through the terminal, while at the same time preventing degradation of the terminal plate due to skin effects.

### SUMMARY

In one exemplary embodiment a battery for a vehicle includes an energy storage portion. A first terminal plate physically contacts, and is electrically connected to, the energy storage portion via a first interior facing surface. A second terminal plate physically contacts, and is electrically connected to, the energy storage portion via a second interior facing surface. The first terminal plate includes at least one groove extending into the first terminal plate from a first exterior facing surface. The first exterior facing surface is opposite the first interior facing surface. A skin effect of the first terminal plate at the first exterior facing surface extends from a circumference of the first terminal plate and from each edge of the at least one groove when an alternating current passes through the first terminal plate.

In addition to one or more of the features described herein the second terminal plate is the same as the first terminal plate.

In addition to one or more of the features described herein the at least one groove comprises straight line grooves extending from a first edge of the first terminal plate to a second edge of the first terminal plate.

In addition to one or more of the features described herein the at least one groove comprises a set of grooves dividing the first exterior facing surface into a set of exterior facing regions, with each exterior facing region having a same two dimensional shape.

In addition to one or more of the features described herein the at least one groove comprises at least one curved groove.

In addition to one or more of the features described herein the at least one groove comprises a set of grooves dividing the first exterior facing surface into a set of exterior facing regions, with the set of exterior facing regions including regions having distinct two dimensional shapes.

In addition to one or more of the features described herein the at least one groove extends into the first terminal plate at least 50% of a depth of the first terminal plate.

In addition to one or more of the features described herein the first terminal plate further comprises a fastener hole extending from the first exterior facing surface to the first interior facing surface.

In addition to one or more of the features described herein, the battery further includes an insulator disposed in the at least one groove, wherein the insulator is electrically insulative.

In addition to one or more of the features described herein the insulator is a rigid insulator and is maintained in the at least one groove via an interference fit.

In addition to one or more of the features described herein the rigid insulator is a single piece insulator.

In addition to one or more of the features described herein the rigid insulator comprises multiple distinct pieces situated in the at least one groove.

In addition to one or more of the features described herein the insulator is an electrically insulative coating applied in the at least one groove.

In addition to one or more of the features described herein the insulator is a flexible insulator.

In addition to one or more of the features described herein the insulator includes a wedge shaped profile having a tapered end closest to the first interior facing surface and a wide end closest to the first exterior facing surface.

In another exemplary embodiment a vehicle includes an electric motor electrically coupled to a battery and configured to convert electric energy into rotational power. A controller is configured to control the electric motor and control a provision of electric power from the battery to the electric motor. The battery includes an energy storage portion, a first terminal plate physically contacting, and electrically connected to, the energy storage portion via a first interior facing surface and a second terminal plate physically contacting, and electrically connected to, the energy storage portion via a second interior facing surface. The first terminal plate includes at least one groove extending into the first terminal plate from a first exterior facing surface the first exterior facing surface being opposite the first interior facing surface. Wherein a skin effect of the first terminal plate at the first exterior facing surface extends from a circumference of the first terminal plate and from each edge of the at least one groove when an alternating current passes through the first terminal plate.

In addition to one or more of the features described the at least one groove comprises straight line grooves extending from a first edge of the first terminal plate to a second edge of the first terminal plate and the at least one groove comprises a set of grooves dividing the first exterior facing surface into a set of exterior facing regions, with each exterior facing region having a same two dimensional shape.

In addition to one or more of the features described the at least one groove comprises at least one curved groove and the at least one groove comprises a set of grooves dividing the first exterior facing surface into a set of exterior facing regions, with the set of exterior facing regions including regions having distinct two dimensional shapes.

In addition to one or more of the features described, the terminal plate further includes an insulator disposed in the at least one groove, wherein the insulator is electrically insulative.

In addition to one or more of the features described the insulator is one of a rigid insulator, a flexible insulator and an insulative coating.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top down view of a vehicle according to one example;

FIG. 2 is an isometric view of a battery cell including terminal plates;

FIG. 3A is an example terminal plate in a top view;

FIG. 3B is the example terminal plate of FIG. 3A a side view;

FIG. 4A is another example terminal plate in a top view;

FIG. 4B is the example terminal plate of FIG. 4A in a side view;

FIG. 5A is another example terminal plate in a top view;

FIG. 5B is the example terminal plate of FIG. 5A in a side view;

FIG. 6 is an example insulator;

FIG. 7 is another example insulator;

FIG. 8 is another example insulator; and

FIG. 9 is a profile view of the example insulators of FIGS. 6, 7 and 8.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to a system including at least a processor and a memory, with the system being configured to perform or cause to be performed at least one operation. The system can be a dedicated controller including a single purpose processor and memory, a general control including one or more modules for performing the operation, a distributed system including multiple controllers in communication with each other and configured to control the operation, or any similar system.

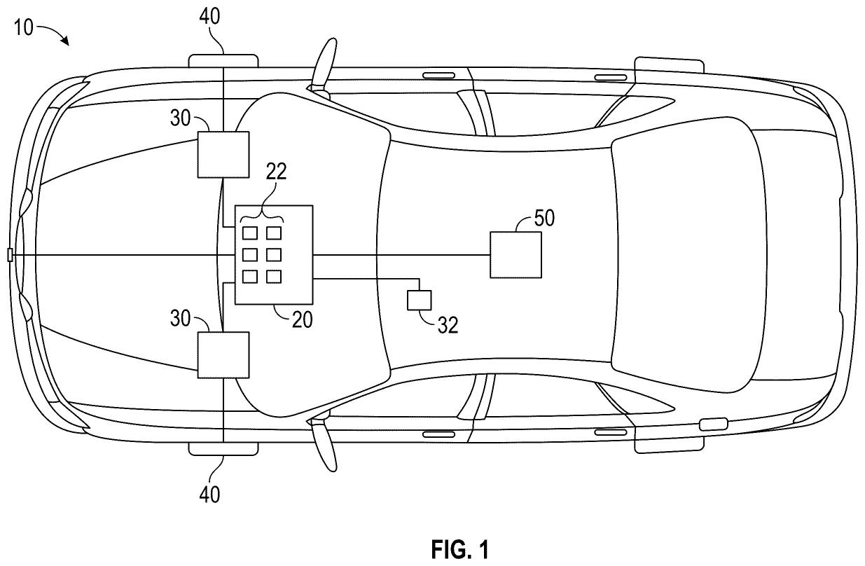

In accordance with an exemplary embodiment, FIG. 1 illustrates a vehicle 10 including a battery 20 for storing electric energy. The battery 20 includes multiple individual battery cells 22. The individual battery cells 22 are connected within the battery 20 and provide output energy to connected drive motors 30. In some examples the battery 20 may also provide electric energy to one or more additional systems 32 within the vehicle 10. The drive motors 30 convert the electric energy into rotational power, and the rotational power is used to rotate wheels 40.

In some vehicle systems, the terminals connecting each cell to the voltage rails connected to the cells 22 are AC voltage rails. As the current increases, a skin effect causes the current to be concentrated on the exterior edges of the terminals. skin effect is the tendency of an alternating electric current (AC) to become distributed within a conductor such that the current density is largest near the surface of the conductor and decreases exponentially with greater depths in the conductor. It is caused by opposing eddy currents induced by the changing magnetic field resulting from the alternating current. The electric current flows mainly at the skin of the conductor, between the outer surface and a level called the skin depth.

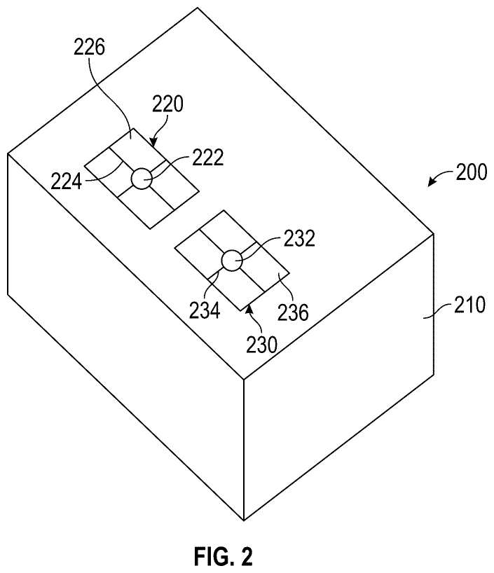

With continued reference to FIG. 1, FIG. 2 illustrates an example cell 200 isolated from the context of the vehicle 10 and the battery 20. The cell 200 includes an energy storage portion 210, a first terminal plate 220 (e.g., a positive terminal) and a second terminal plate 230 (e.g., a negative terminal). The energy storage portion 210 can be any conventional energy storage configuration.

Each of the terminal plates 220, 230 is constructed of a conductive material and includes a fastener hole 222, 232 through which a fastener protrudes and maintains a physical connection between the terminal plate 220, 230 and the energy storage portion 210. In addition, the terminal plates 220, 230 include grooves 224, 234 that extend partially through the terminal plate and divide the terminal plate 220, 230 into sections 226, 236.

When the grooves 224, 234 are linear (e.g. straight lines), the sections 226, 236 may be designed to have the same general shape without being exactly the same size. In such an example, the number of sides of each section 226, 236 and an approximate ratio of the side lengths of each section 226, 236 is the same.

In some alternative examples, the grooves 224, 234 may include one or more non-linear (e.g. curved) groove. A non-linear groove is a groove that traverses the surface of the terminal plates 220, 230 in a non-linear manner (e.g. via curved or serpentine paths). The curvature of the non-linear groove may be determined using empirical studies, simulations and/or machine learning based analysis. In one particular example, the curvature can be used to ensure that a surface area of each section 226, 236 is the same, within tolerances.

In one example, the grooves 224, 234 extend at least 50% of the depth of the terminal plate 220, 230. In some implementations it may be desirable to extend the depth to as great a percentage of the terminal plate 220, 230 depth as possible without structurally compromising the terminal plate 220, 230.

By dividing the terminal plates 220, 230 into sections, the skin effect occurs at the outer circumference of each section 226, 236 and a configuration can be constructed where the skin depth (portion of the conductor in which the skin effect concentrates current) covers most or all of the terminal plate 220, 230. The skin effect covering most or all of the terminal plate 220, 230 in turn reduces heat generated as current passes through the terminal plates 220, 230, and improves a lifecycle of the terminal plates 220, 230.

In one example, the terminal plates 220, 230 are the same and are therefore able to be pulled from a pool of uniform terminal plates 220, 230 during a manufacturing process.

In another example, the terminal plate 220 for the negative terminal and the terminal plate 230 for the positive terminal may have distinct configurations requiring distinct components during the assembly process.

With continued reference to FIGS. 1 and 2, FIGS. 3-5 illustrate example terminal plates 300, 400, 500 in a top view (3A, 4A, and 5A) and a side view (3B, 4B, and 5B).

Each of the terminal plates 300, 400, 500 has a thickness 302, 402, 502. The thickness is a length of the terminal plate 300, 400, 500 from a first surface 304, 404, 504 to a second surface 306, 406, 506. While installed on the cell 200 (illustrated in FIG. 2) the first surface 304, 404, 504 is in contact with internal components of the cell allowing for electrical current to pass through the terminal plate 300, 400, 500.

Each terminal plate 300, 400, 500 includes a through hole 308, 408, 508. The through hole 308, 408, 508 receives a fastener (not pictured), and the fastener maintains the terminal plate 300, 400, 500 in contact with the cell 200. In alternative implementations the through hole 308, 408, 508 may be replaced with alternate fastening configurations able to maintain the contact between the first surface 304, 404, 504 and the cell 200 and/or multiple through holes may be used depending on the specifications of the particular implementation.

Each terminal plate 300, 400, 500 includes one or more grooves 310, 410, 510. The grooves are etched slots extending from the second surface 306, 406, 506 toward the first surface 304, 404, 504. Each of the grooves 310, 410, 520 extends into the terminal plate 300, 400, 500 for a portion of the thickness 302, 402, 502 resulting in a terminal plate 300, 400, 500 structure where the first surface 304, 404, 504 has a single continuous surface area and the second surface 306, 406, 506 (facing outward and facilitating external electrical connections) includes multiple distinct surface areas 306A-D, 406A-C, 506A-K.

While AC current is passing through the terminal plates 300, 400, 500 the skin effect causes the current to be concentrated near the edges of the terminal plate. By adding the grooves 310, 410, 510, and splitting the exterior portion of the terminal plate 300, 400, 500 into multiple surface areas 306A-C, 406A-D, 506A-K, the skin effect can be extended to cover all, or most, of the terminal plate thereby distributing the current throughout the entire terminal plate and minimizing heat generation (and corresponding degradation) across the terminal plate 300, 400, 500.

In certain examples, it may be desirable to provide an insulator 320 in the grooves 310, 410, 510 in order to prevent electrical conduction across the grooves either due to sparking, contamination entering the grooves 310, 410, 510, or any other reason. The insulator 320 can be any insulative material able to insulate the sections of the terminal plate 300, 400, 500 including rigid insulators 320 inserted after the grooves 510 are created, flexible insulators inserted after the grooves 310, 410, 510 are created and/or insulative coatings applied after the grooves 310, 410, 510 are created.

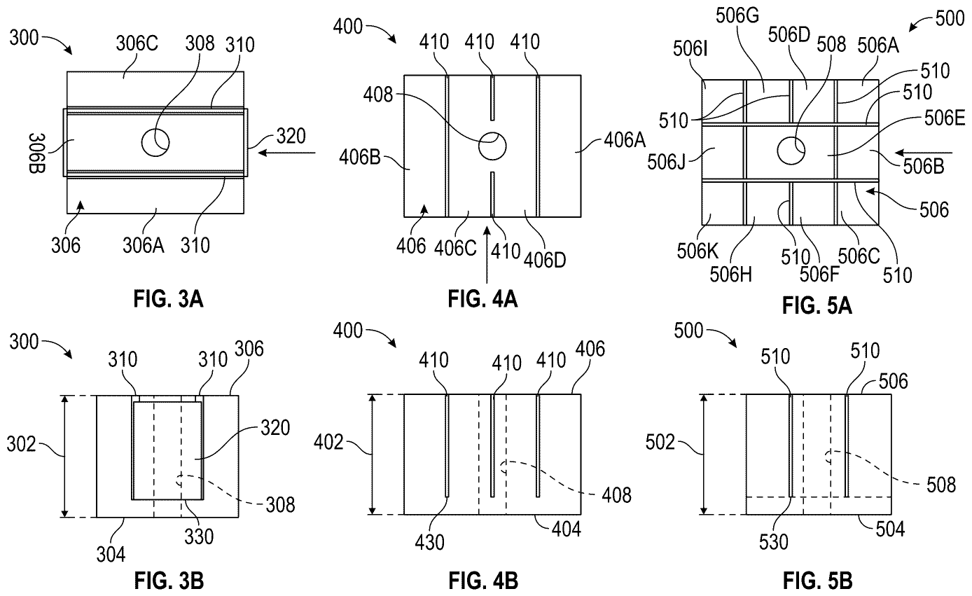

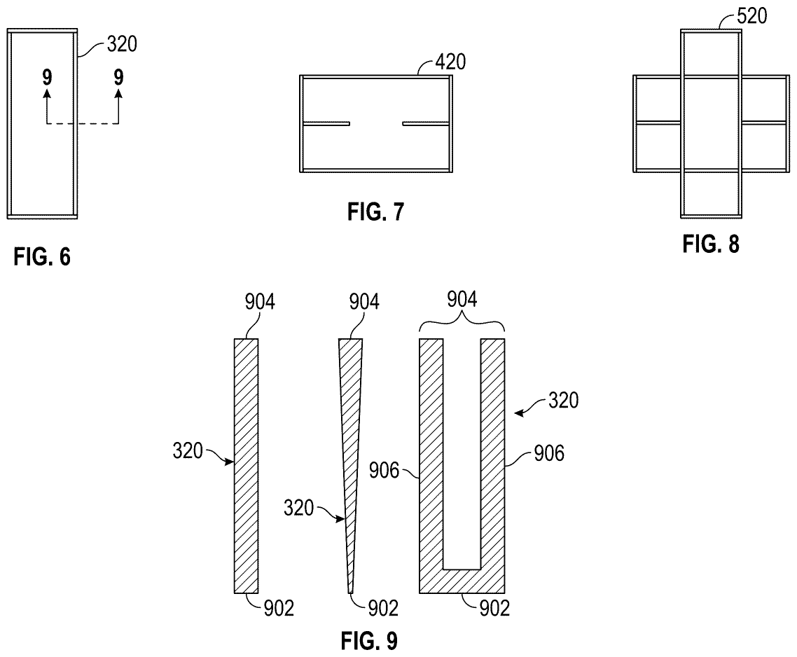

With continued reference to FIGS. 3-5, FIGS. 6-8 illustrate example rigid insulators 320, 420, 520 for insertion in the terminal plates 300, 400, 500. Each of the illustrated insulators 320, 420, 520 is a single piece of the insulative material (e.g. plastic, rigid rubber, etc.) shaped to match the corresponding grooves 310, 410, 510. In one example, the rigid insulator 320, 420, 520 is maintained in place within the grooves 310, 410, 510 using an interference fit (alternately referred to as a pressed fit or a friction fit).

The rigid insulator 320, 420, 520 has a height aligned with the depth of the groove 310, 410, 510 with the height of the rigid insulator 320, 420, 520 being less than the depth of the groove 310, 410, 510. When installed in the terminal plate 300, 400, 500, the rigid insulator 320, 420 520 is seated against a base 330, 430, 530 of the groove 310, 410, 510.

In some alternate examples, the single piece of insulative material may be replaced with multiple pieces (e.g. bars) individually inserted into the grooves 310, 410, 510.

In yet further alternate examples, the rigid insulator 320, 420, 520 may be replaced with an electrically insulative coating applied to the interior of the grooves 310, 410, 510. As with the rigid insulator the coating is applied to the base 330, 430, 530 and extends up the walls of the groove 310, 410, 510 with a portion at the top of each groove being uncoated. The particular amount left uncoated depends on the specifics of the application, and may be as little as 5% of the height of the groove 310, 410, 510.

With continued reference to FIGS. 1-8, FIG. 9 illustrates a side profile of insulators, such as the rigid insulator 320, flexible insulators and/or coating insulators. In a basic example, the side profile can be a rectangular shape with a base 902 and a top 904 of the insulator having the same width. In another example, the side profile is wedge shaped, with the base 902 having a smaller width than the top 904. In another example, the profile of the insulator is U-shaped with a base 902 extending a full width of the groove, and two outwardly extending walls 906.

The wedge shaped profile may be particularly beneficial in conjunction with a flexible insulator, as the tapered point allows the insulator to be inserted despite the flexible nature. The U-shaped profile may be particularly beneficial in conjunction with a coating due to ease of manufacturing. However, any of the profiles may be utilized with any of the insulator materials. In yet further examples, a single insulator may utilize a combination of any or all of the profiles to similar effect

While illustrated in the examples of FIGS. 3-5 as straight lines dividing the terminal plates 300, 400, 500 into approximately even segments, it is appreciated that the particular shape of the grooves 310, 410, 510 and surface areas of the segments is not required to be uniform. Analysis of the terminal plate may be performed using empirical evidence, machine learning, physical modeling, and/or any combination thereof. The resultant grooves may be curved, complex, straight, or any combination determined to provide the best skin effect using the analysis.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery for a vehicle, the battery comprising:
an energy storage portion;
a first terminal plate physically contacting, and electrically connected to, the energy storage portion via a first interior facing surface;
a second terminal plate physically contacting, and electrically connected to, the energy storage portion via a second interior facing surface;
the first terminal plate comprising at least one groove extending into the first terminal plate from a first exterior facing surface, the first exterior facing surface being opposite the first interior facing surface; and
wherein a skin effect of the first terminal plate at the first exterior facing surface extends from a circumference of the first terminal plate and from each edge of the at least one groove when an alternating current passes through the first terminal plate.

2. The battery of claim 1, wherein the second terminal plate is the same as the first terminal plate.

3. The battery of claim 1, wherein the at least one groove comprises straight line grooves extending from a first edge of the first terminal plate to a second edge of the first terminal plate.

4. The battery of claim 3, wherein the at least one groove comprises a set of grooves dividing the first exterior facing surface into a set of exterior facing regions, with each exterior facing region having a same two dimensional shape.

5. The battery of claim 1, wherein the at least one groove comprises at least one curved groove.

6. The battery of claim 5, wherein the at least one groove comprises a set of grooves dividing the first exterior facing surface into a set of exterior facing regions, with the set of exterior facing regions including regions having distinct two dimensional shapes.

7. The battery of claim 1, wherein the at least one groove extends into the first terminal plate at least 50% of a depth of the first terminal plate.

8. The battery of claim 1, wherein the first terminal plate further comprises a fastener hole extending from the first exterior facing surface to the first interior facing surface.

9. The battery of claim 1, further comprising an insulator disposed in the at least one groove, wherein the insulator is electrically insulative.

10. The battery of claim 9, wherein the insulator is a rigid insulator and is maintained in the at least one groove via an interference fit.

11. The battery of claim 10, wherein the rigid insulator is a single piece insulator.

12. The battery of claim 10, wherein the rigid insulator comprises multiple distinct pieces situated in the at least one groove.

13. The battery of claim 9, wherein the insulator is an electrically insulative coating applied in the at least one groove.

14. The battery of claim 9, wherein the insulator is a flexible insulator.

15. The battery of claim 14, wherein the insulator includes a wedge shaped profile having a tapered end closest to the first interior facing surface and a wide end closest to the first exterior facing surface.

16. A vehicle comprising:
an electric motor electrically coupled to a battery and configured to convert electric energy into rotational power;
a controller configured to control the electric motor and control a provision of electric power from the battery to the electric motor;
the battery including:
an energy storage portion;
a first terminal plate physically contacting, and electrically connected to, the energy storage portion via a first interior facing surface;
a second terminal plate physically contacting, and electrically connected to, the energy storage portion via a second interior facing surface;
the first terminal plate comprising at least one groove extending into the first terminal plate from a first exterior facing surface, the first exterior facing surface being opposite the first interior facing surface; and
wherein a skin effect of the first terminal plate, at the first exterior facing surface extends from a circumference of the first terminal plate and from each edge of the at least one groove when an alternating current passes through the first terminal plate.

17. The vehicle of claim 16, wherein the at least one groove comprises straight line grooves extending from a first edge of the first terminal plate to a second edge of the first terminal plate and the at least one groove comprises a set of grooves dividing the first exterior facing surface into a set of exterior facing regions, with each exterior facing region having a same two dimensional shape.

18. The vehicle of claim 16, wherein the at least one groove comprises at least one curved groove and the at least one groove comprises a set of grooves dividing the first exterior facing surface into a set of exterior facing regions, with the set of exterior facing regions including regions having distinct two dimensional shapes.

19. The vehicle of claim 16, further comprising an insulator disposed in the at least one groove, wherein the insulator is electrically insulative.

20. The vehicle of claim 19, wherein the insulator is one of a rigid insulator, a flexible insulator and an insulative coating.
